(19) United States
(12) Patent Application Publication
(10) Pub. No.: US 2020/0165135 A1
(43) Pub. Date: May 28, 2020

(54) CARBON NANOTUBE COMPLEX AND METHOD FOR MANUFACTURING SAME

(71) Applicant: HITACHI ZOSEN CORPORATION, Osaka-shi, Osaka (JP)

(72) Inventor: Tetsuya INOUE, Osaka-shi, Osaka (JP)

(21) Appl. No.: 16/610,736

(22) PCT Filed: May 8, 2018
(86) PCT No.: PCT/JP2018/017836

§ 371 Date: Nov. 4, 2019

(30) Foreign Application Priority Data
May 12, 2017 (JP) 2017-096059

(51) Int. Cl. C01B 32/168; C08K 3/04; C08L 101/00; C08K 9/02; B82Y 30/00; B82Y 40/00

(52) U.S. Cl. CPC C01B 32/168; C08K 3/04; C08L 101/00; B82Y 40/00; B82Y 30/00; C01B 2202/08; C08K 9/02

(57) ABSTRACT

An object is to maintain high friction state even after repeated use. A carbon nanotube composite includes: a vertically aligned carbon nanotube array composed of vertically oriented carbon nanotubes coated with amorphous carbon; and a base layer which has the vertically aligned carbon nanotube array fixed thereto. One end portion, which is one of the opposite end portions in the direction of orientation of the vertically oriented carbon nanotubes, is exposed on the outside of the base layer.

### TECHNICAL FIELD

The present invention relates to a carbon nanotube composite and a method of producing the carbon nanotube composite.

### BACKGROUND ART

An adhesive member making use of carbon nanotubes is known as a conventional technique.

For example, Patent Literature 1 discloses an adhesive member composed of a base and a carbon nanotube array fixed to the base. The adhesive member disclosed in Patent Literature 1 is such that, when an object is placed on the adhesive member, van der Waals forces act between the carbon nanotubes and the object, and thereby the object adheres to the adhesive member.

### CITATION LIST

### Patent Literature

[Patent Literature 1]

Japanese Patent No. 5199753 (Date of registration: Feb. 15, 2013)

### SUMMARY OF INVENTION

### Technical Problem

However, according to the adhesive member disclosed in Patent Literature 1, when the object is placed on the adhesive member, the carbon nanotubes are bent, resulting in aggregation of adjacent nanotubes. The adhesive member disclosed in Patent Literature 1 thus has an issue in that it is not suited for repeated attaching/detaching of objects.

An object of an aspect of the present invention is to provide a carbon nanotube composite that is capable of maintaining its high friction state even after repeated use.

### Solution to Problem

In order to attain the above object, a carbon nanotube composite in accordance with an aspect of the present invention includes: vertically oriented carbon nanotubes coated with amorphous carbon; and a base layer which has the vertically oriented carbon nanotubes fixed thereto, each of the vertically oriented carbon nanotubes having first and second opposite ends in a direction of orientation of the vertically oriented carbon nanotubes, at least one of the first and second opposite ends being exposed on an outside of the base layer.

### Advantageous Effects of Invention

An aspect of the present invention makes it possible to provide a carbon nanotube composite that is capable of maintaining its high friction state even after repeated use.

### BRIEF DESCRIPTION OF DRAWINGS

FIG. 1 illustrates a configuration of a carbon nanotube composite in accordance with Embodiment 1 of the present invention. (a) of FIG. 1 is a top view of the carbon nanotube composite, and (b) of FIG. 1 is a cross-sectional view taken along line A-A in (a) of FIG. 1.

FIG. 2 is an enlarged view of an end portion of one of carbon nanotubes of the carbon nanotube composite.

FIG. 3 illustrates the carbon nanotube composite on which an object is placed. (a) of FIG. 3 is a top view of such a carbon nanotube composite, and (b) of FIG. 3 is a cross-sectional view taken along line A-A in (a) of FIG. 3.

(a) to (f) of FIG. 4 schematically illustrate a method of producing the carbon nanotube composite.

FIG. 5 illustrates other examples of the shape of a region in which carbon nanotubes are exposed on the outside of the carbon nanotube composite.

FIG. 6 is a cross-sectional view illustrating a configuration of a carbon nanotube composite which is a variation of the carbon nanotube composite in accordance with Embodiment 1.

(a) to (d) of FIG. 7 illustrate a method of producing the carbon nanotube composite.

FIG. 8 illustrates a configuration of a carbon nanotube composite in accordance with Embodiment 2 of the present invention. (a) of FIG. 8 is a top view of the carbon nanotube composite, and (b) of FIG. 8 is a cross-sectional view taken along line A-A in (a) of FIG. 8.

(a) to (f) of FIG. 9 schematically illustrate a method of producing the carbon nanotube composite.

### DESCRIPTION OF EMBODIMENTS

### Embodiment 1

The following description will discuss a carbon nanotube composite 1 in accordance with Embodiment 1 with reference to the drawings. Hereinafter, carbon nanotubes are referred to as “CNTs”, and a carbon nanotube composite is referred to as “CNT composite”. In this specification, the numerical range “A to B” means “not less than A and not more than B”.

(Configuration of Carbon Nanotube Composite 1)

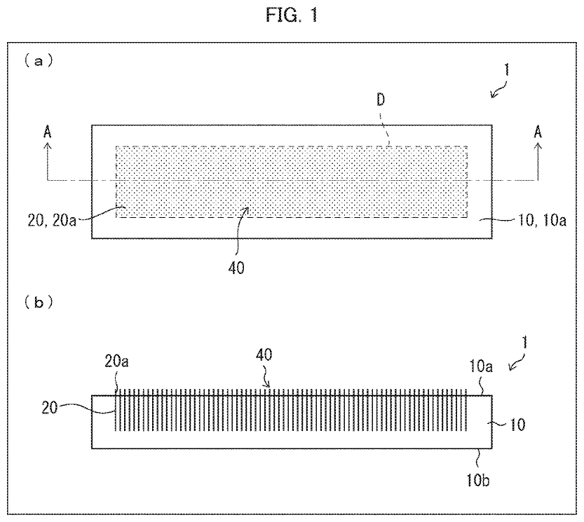

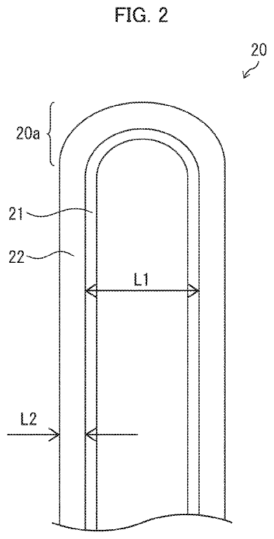

The following description will discuss a configuration of the CNT composite 1 with reference to FIGS. 1 and 2.

FIG. 1 illustrates a configuration of the CNT composite 1. (a) of FIG. 1 is a top view of the CNT composite 1, and (b) of FIG. 1 is a cross-sectional view taken along line A-A in (a) of FIG. 1.

As illustrated in (a) and (b) of FIG. 1, the CNT composite 1 includes a base layer 10 and a vertically aligned carbon nanotube array 40.

The base layer 10 is made of an elastic material (such as rubber) which is a polymeric material, and is substantially in the shape of a cuboid. The base layer 10 may be made of, for example, natural rubber, urethane rubber, silicone rubber, fluororubber, and/or the like. The base layer 10 has, as illustrated in FIG. 1, a first face 10a and a second face 10b that is opposite from the first face 10a.

The vertically aligned CNT array 40 is composed of a plurality of unidirectionally oriented CNTs 20. In other words, the vertically aligned CNT array 40 is a group of CNTs. FIG. 2 is an enlarged view of an end portion of one of the CNTs 20. As illustrated in FIG. 2, the CNTs 20 is composed of a tubular layer 21 and an amorphous layer 22 coated on the tubular layer 21.

The tubular layer 21 has an outer diameter (L1 in FIG. 2) of 10 nm to 12 nm and a length of 50 μm to 200 μm, and is made up of five to ten layers. The tubular layer 21 is, in other words, a general CNT which does not have the amorphous layer 22 (described later) coated thereon.

The amorphous layer 22 is made of amorphous carbon. As illustrated in FIG. 2, the amorphous layer 22 is coated on the outer circumferential surface of the tubular layer 21. The amorphous layer 22 has a thickness (L2 in FIG. 2) of 5 to 10 nm. It is preferable that the amorphous layer 22 does not overlap the amorphous layer 22 of an adjacent CNT 20.

The CNT composite 1 is such that, as illustrated in FIG. 1, a plurality of the CNTs 20 (i.e., vertically aligned carbon nanotube array 40) are oriented in a direction from the first face 10a toward the second face 10b and are fixed to (impregnated in) the base layer 10. In other words, a plurality of CNTs 20 are oriented in a predetermined direction and embedded in the base layer 10. That is, the direction from the first face 10a toward the second face 10b is the same as the direction of orientation of the CNTs 20 (such a direction hereinafter may be referred to as “orientation direction”). One end portion 20a (one end), which is one of the opposite end portions in the orientation direction of each of the CNTs 20, is exposed on the first face 10a of the base layer 10. In other words, at least one of the opposite ends in the direction of orientation of the vertically aligned CNT array 40 is exposed on the first face 10a of the base layer 10. In the CNT composite 1, the end portion 20a projects outward form the first face 10a of the base layer 10 by 1 μm to 50 μm. The plurality of CNTs 20 are preferably arranged such that the number of CNTs 20 per square centimeter of a cross-sectional area that is perpendicular to the orientation direction is 10⁹ to 10¹⁰. In the CNT composite 1 in accordance with Embodiment 1, the shape of a region D, which is part of a plane containing the first face 10a and in which the CNTs 20 are exposed (such a region is hereinafter referred to as “region D” for short), is a rectangle (see (a) of FIG. 1).

(Example of Use of Carbon Nanotube Composite 1)

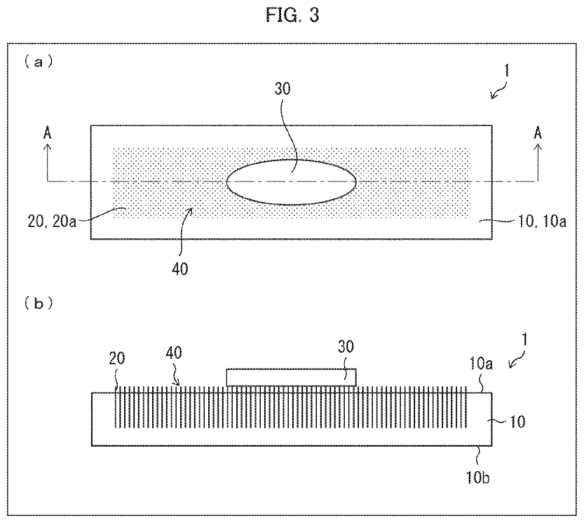

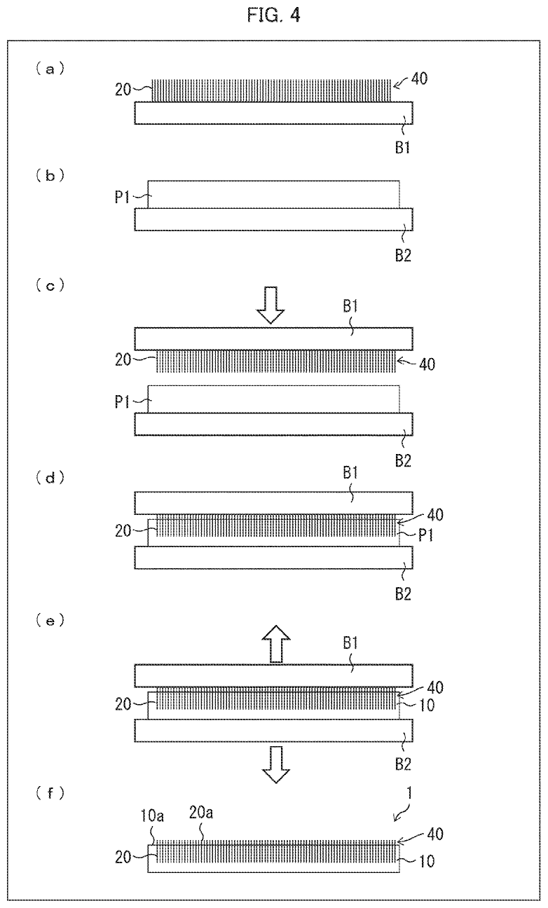

The following description will discuss an example of use of the CNT composite 1 with reference to FIG. 3. FIG. 3 illustrates the CNT composite 1 on which an object 30 is placed. (a) of FIG. 3 is a top view of such a CNT composite 1, and (b) of FIG. 3 is a cross-sectional view taken along line A-A in (a) of FIG. 3.

As illustrated in (a) and (b) of FIG. 3, in a case where the object 30 is placed on the CNT composite 1 such that the object 30 is within an area where CNTs 20 are exposed, the end portions 20a of CNTs 20 make contact with the surface of the object 30. When the end portions 20a of CNTs 20 make contact with the surface of the object 30, the end portions 20a dig into (stick into) the surface of the object 30, because the outer diameter of each of the CNTs 20 is as small as several tens of nanometers. It follows that a very large frictional force (gripping force) is generated between the CNT composite 1 and the object 30. The coefficient of static friction between the CNT composite 1 and a copper sheet was actually measured, and found to be 0.7 to 0.8.

As described earlier, the CNTs 20 in Embodiment 1 each have the amorphous layer 22 coated on the tubular layer 21. This prevents or reduces the likelihood that, when the CNTs 20 bend upon receiving a pressure from the object 30 in the orientation direction, adjacent CNTs 20 will aggregate together by van der Waals forces. It follows that the CNTs 20 are capable of recovering their original orientation states upon release of the pressure. This makes it possible for the CNT composite 1 to maintain its high friction state even after repeated use.

Furthermore, since the CNTs 20 each have the amorphous layer 22 coated on the tubular layer 21, the CNTs 20 are higher in strength and elasticity than CNTs not coated with the amorphous layer 22. It follows that the CNTs 20 are less likely to be broken even when subjected to a pressure from the object 30 in the orientation direction, and are capable of recovering their original orientation states upon release of the pressure.

Furthermore, since a plurality of CNTs 20 are oriented, the region D is highly water repellent. It follows that the CNT composite 1 experiences no or little reduction in gripping force and is capable of generating a large frictional force (gripping force) between the end portions 20a of the CNTs 20 and the object 30, even if the object 30 is wet with water.

Furthermore, since the CNTs 20 are fixed to the base layer 10, the base layer 10 has improved wear resistance.

The CNT composite 1 in accordance with Embodiment 1, in which the base layer 10 is made of an elastic material, can be applied to, for example, a sole of a shoe (e.g., sports shoes), a rubber for a table tennis paddle, and the like.

The CNT composite 1 in accordance with Embodiment 1, when applied to a shoe, makes it possible to generate a large frictional force between the shoe and the ground. This makes it possible to transmit much force to the ground. Furthermore, since the CNTs 20 are water-repellent as described earlier, the shoe achieves a large force to grip the ground and does not slip even if the ground is wet.

The CNT composite 1 in accordance with Embodiment 1, when applied to a table tennis paddle, makes it possible to generate a large frictional force between the paddle and a ball. This makes it possible for a user to make a fast spin ball. It is also possible for the user to easily hit the ball back to the opponent even if the ball is spinning fast.

Note that, although the end portions 20a of the CNT composite in accordance with Embodiment 1 project outward from the first face 10a of the base layer 10, the CNT composite of the present invention is not limited as such. Specifically, the CNT composite of the present invention is not limited, provided that at least one (e.g., end portion 20a) of the opposite end portions in the orientation direction of the CNTs 20 is exposed on the first face 10a of the base layer 10. In an aspect of the present invention, the CNT composite may be arranged such that a plane formed by the end portions 20a of the plurality of CNTs 20 coincides with the first face 10a of the base layer 10. This arrangement also allows contact of the end portions 20a of the CNTs 20 with the surface of the object 30, and thus makes it possible to generate a very large frictional force between the CNT composite 1 and the object 30.

Further note that, although the base layer 10 in accordance with Embodiment 1 is made of an elastic material, the base layer of the present invention is not limited as such. In an aspect of the present invention, the CNT composite may be arranged such that the base layer 10 is made of a polymeric material other than elastic materials. The base layer 10 may be made of, for example, a resin (thermoplastic resin, thermosetting resin) or a metal. The CNT composite 1 can also be used as a reusable adhesive member.

(Method of Producing Carbon Nanotube Composite 1)

The following description will discuss a method of producing a CNT composite in accordance with Embodiment 1, with reference to FIG. 4.

(a) to (f) of FIG. 4 schematically illustrate a method of producing a CNT composite 1.

The method of producing a CNT composite 1 in accordance with Embodiment 1 includes: a carbon nanotube preparing step (CNT preparing step); a polymeric material applying step; and a transferring step.

The CNT preparing step includes preparing, on a substrate B1, a plurality of unidirectionally (perpendicularly to the substrate B1) oriented CNTs 20 coated with amorphous carbon (see (a) of FIG. 4).

The substrate B1 is a thin steel sheet (for example, a stainless steel sheet having a thickness of about 20 μm to several millimeters). The substrate B1 is prepared in the following manner: a substrate is washed (for example, with alkali); then a passive film made of silica, alumina or the like is formed on the top face of the substrate; and fine catalytic particles of a metal are applied on the top face of the passive film. The metal of the fine catalytic particles is, for example, iron (Fe), cobalt (Co), or nickel (Ni).

In the CNT preparing step, first, the substrate B1 is introduced into a heating chamber which is maintained at a predetermined degree of vacuum (for example, 3 kPa to 50 kPa, preferably 3 kPa to 10 kPa), and the temperature of the substrate B1 is raised to a first temperature (for example, 640° C. to 720° C.) in a mixed gas (for example, a mixture of nitrogen gas and hydrogen gas) atmosphere.

Next, a source gas (for example, a low hydrocarbon gas such as acetylene, methane or butane) is supplied to the top face of the substrate B1. This allows tubular carbon layers (i.e., CNTs, tubular layers 21) to grow on the fine catalytic particles on the top face of the substrate B1 to reach a desired height (length).

Next, in the foregoing mixed gas atmosphere, the temperature of the substrate K is raised to a second temperature (for example, 780° C. to 840° C.) which is higher than the first temperature.

Next, the foregoing source gas is again supplied to the CNTs formed on the substrate B1. This allows a predetermined amount of amorphous carbon (i.e., amorphous layer 22) to form on the outer surfaces of the tubular layers 21. Then, the substrate B1 is allowed to cool slowly while receiving supply of the mixed gas. This results in coating of the tubular layers 21 with amorphous carbon (amorphous layers 22). In this way, a plurality of CNTs 20 oriented unidirectionally (perpendicularly to the substrate B1) are prepared on the substrate B1. That is, the vertically aligned carbon nanotube array 40 is prepared on the substrate B1.

The polymeric material applying step includes applying an elastic material (i.e., base layer 10) precursor solution P1 onto a substrate B2 (see (b) of FIG. 4).

The transferring step (fixing step) includes transferring, to the base layer 10 (in other words, the elastic material precursor solution P1) applied on the substrate B2, the plurality of CNTs 20 (i.e., vertically aligned carbon nanotube array 40) prepared on the substrate B1. Specifically, in the transferring step, first, as illustrated in (c) of FIG. 4, the plurality of CNTs 20 prepared on the substrate B1 are pressed into (inserted into) the elastic material precursor solution P1 applied on the substrate B2, in the direction indicated by the arrow in (c) of FIG. 4. With this, as illustrated in (d) of FIG. 4, the CNTs 20 are inserted in the elastic material precursor solution P1. Next, the elastic material precursor solution P1 is heated (or dried) and thereby allowed to cure. This results in formation of the base layer 10, and the plurality of CNTs 20 are fixed to the base layer 10.

Next, the substrate B1 and the CNTs 20 are separated from each other with use of, for example, a cutter, and, as illustrated in (e) of FIG. 4, the substrate B1 is peeled away from the CNTs 20 in the upward direction in (e) of FIG. 4. Similarly, the substrate B2 and the base layer 10 are separated from each other with use of, for example, a cutter, and the substrate B2 is peeled away from the base layer 10 in the downward direction in (e) of FIG. 4. In this way, the plurality of CNTs 20 are transferred to the base layer 10.

In this way, it is possible to produce a CNT composite 1 in which the end portions 20a of the CNTs 20 are exposed on the first face 10a of the base layer 10 (see (f) of FIG. 4).

Note that, although the CNT composite 1 in accordance with Embodiment 1 is arranged such that the region D is a rectangle, the CNT composite of the present invention is not limited as such. In an aspect of the present invention, the shape of the region D of the CNT composite can be changed to any shape according to the purpose of use of the CNT composite, by controlling the shape of the array of CNTs 20 formed in the CNT preparing step. In an aspect of the present invention, the CNT composite may include a plurality of regions D.

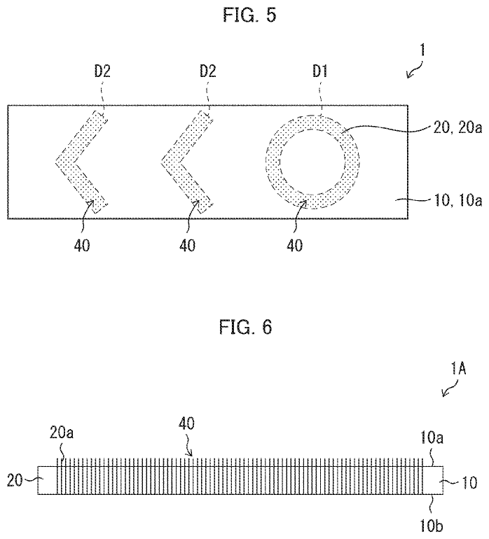

Note that the shape of a region formed by the end portions 20a of the plurality of CNTs 20 prepared on the substrate B (this region is, in other words, vertically aligned CNT array 40) can be changed by controlling, in the CNT preparing step, where on the substrate B1 the fine catalytic particles are applied. This makes it possible to change the shape of the region D to any shape. FIG. 5 illustrates other examples of the shape of the region D. In the CNT preparing step, the fine catalytic particles may be applied onto the substrate B1 in the form of a ring (circle) or in the form of a broken line, thereby making it possible to form a region D in the form of a ring (region D1 in FIG. 5) or a region D in the form of a broken line (region D2 in FIG. 5). This also allows for a design in which a plurality of vertically aligned CNT arrays 40 are exposed in a plurality of areas as illustrated in FIG. 5.

<Variation 1>

The following description will discuss a CNT composite 1A, which is a variation of the CNT composite 1 in accordance with Embodiment 1, with reference to the drawings. For convenience of description, members having functions identical to those described in Embodiment 1 are assigned identical referential numerals, and their descriptions are omitted here.

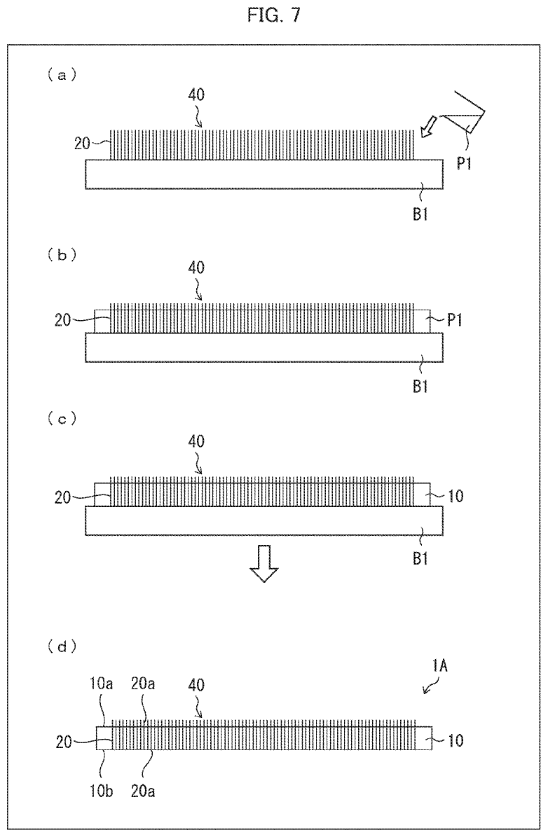

FIG. 6 is a cross-sectional view illustrating a configuration of the CNT composite 1A. As illustrated in FIG. 6, the CNT composite 1A is arranged such that the end portions 20b of the plurality of CNTs 20 (i.e., vertically aligned carbon nanotube array 40), which are opposite from the end portions 20a in the orientation direction, are exposed on the second face 10b of the base layer 10. A plane formed by the end portions 20b coincides with the second face 10b of the base layer 10. With this arrangement, the CNT composite 1A can have high friction areas (i.e., areas where CNTs 20 are exposed) at two opposite planes (i.e., a plane containing the first face 10a and a plane containing the second face 10b).

The following description will discuss a method of producing a CNT composite 1A in accordance with Variation 1, with reference to FIG. 7. (a) to (d) of FIG. 7 illustrate a method of producing a CNT composite 1.

The method of producing a CNT composite 1 in accordance with Variation 1 includes: a CNT preparing step; a polymeric material filling step; a polymeric material curing step; and a peeling step. The CNT preparing step is the same as that described in Embodiment 1, and therefore descriptions therefor are omitted here.

The polymeric material filling step includes pouring, into gaps between a plurality of CNTs 20 prepared on the substrate B1, an elastic material precursor solution P1 obtained by dissolving an elastic material precursor in an organic solvent (e.g., acetone), and thereby filling the gaps between the CNTs 20 with the elastic material precursor solution P1 (see (a) and (b) of FIG. 7). The elastic material precursor solution P1 is filled into the gaps such that the end portions 20a project outward from the elastic material precursor solution P1 by 1 nm to 50 nm. Note that the polymeric material filling step is carried out preferably in a negative pressure. This allows the elastic material precursor solution P1 to more easily flow into the gaps between the plurality of CNTs 20.

The polymeric material curing step (fixing step) includes allowing the elastic material precursor solution P1, which was filled in the gaps between the plurality of CNTs 20 in the polymeric material filling step, to cure by heating (or drying) the elastic material precursor solution P1. The polymeric material curing step results in formation of the base layer 10 as illustrated in (c) of FIG. 7, and thereby the plurality of CNTs 20 (i.e., vertically aligned CNT array 40) are fixed to the base layer 10.

The peeling step includes separating the substrate B1 and the CNTs 20 from each other with use of, for example, a cutter, and peeling the substrate B1 away from the CNTs 20 in the downward direction in (c) of FIG. 7.

In this way, it is possible to produce a CNT composite 1A in which the first end portions 20a of the CNTs 20 are exposed on the first face 10a of the base layer 10 whereas the second end portions 20b, which are opposite from the first end portions 20a, of the CNTs 20 are exposed on the second face 10b of the base layer 10 (see (d) of FIG. 7).

### Embodiment 2

The following description will discuss another embodiment of the present invention with reference to the drawings. For convenience of description, members having functions identical to those described in Embodiment 1 are assigned identical referential numerals, and their descriptions are omitted here.

(Configuration of Carbon Nanotube Composite 1B)

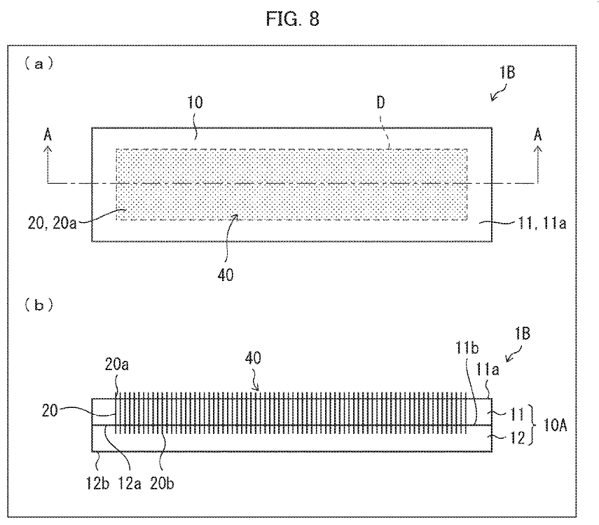

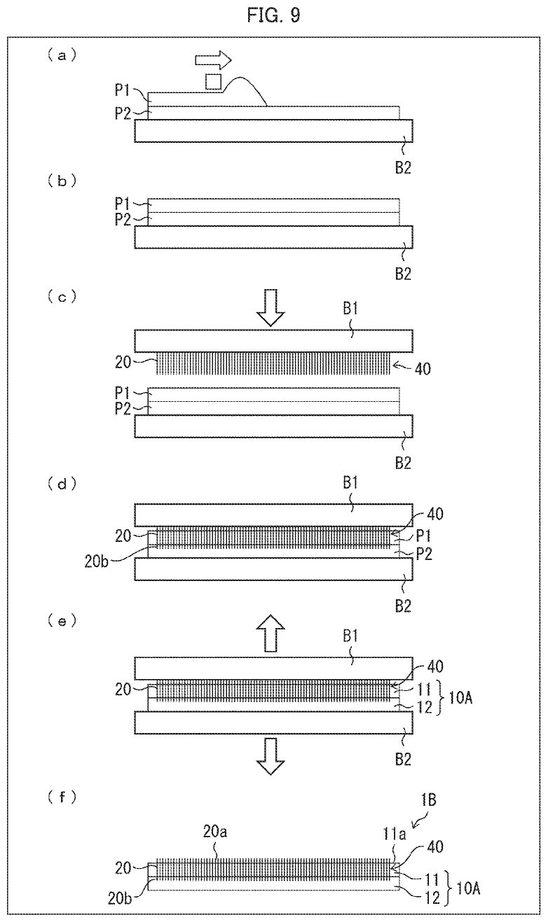

The following description discusses a configuration of a CNT composite 1B in accordance with Embodiment 2, with reference to FIG. 8. FIG. 8 illustrates a configuration of the CNT composite 1B. (a) of FIG. 8 is a top view of the CNT composite 1B, and (b) of FIG. 8 is a cross-sectional view taken along line A-A in (a) of FIG. 8. As illustrated in FIG. 8, the CNT composite 1B includes a base layer 10A and CNTs 20.

The base layer 10A includes a first layer 11 and a second layer 12.

The first layer 11 is made of an elastic material (such as rubber) which is a polymeric material. The first layer 11 has a first face 11a and a second face 11b that is opposite from the first face 11a. The first face 11a and the second face 11b are opposite from each other in the direction of orientation of the CNTs 20.

The second layer 12 is made of a resin which is a polymeric material. The second layer 12 has a first face 12a and a second face 12b which are opposite from each other. The first face 12a abuts the second face 12b of the first layer 11.

The CNT composite 1B is arranged such that end portions 20a of the CNTs 20 are exposed on the first face 11a of the first layer 11 and that end portions 20b, which are opposite from the end portions 20a, of the CNTs 20 are located inside the second layer 12.

As described above, the base layer 10A in accordance with Embodiment 2 includes the first layer 11, which is made of an elastic material, and the second layer 12, which is made of a resin. The CNT composite 1A arranged like this is elastic on one side and is highly rigid on the other side. That is, the CNT composite 1B has a plurality of functions.

Furthermore, in the CNT composite 1B, a plurality of CNTs 20 are located such that they are present within the first layer 11 and the second layer 12. The CNTs 20 arranged like above strengthen the connection between the first layer 11 and the second layer 12 (in other words, the CNTs 20 provide an anchor effect). This makes it possible to prevent or reduce the likelihood that the first layer 11 and the second layer 12 will be detached from each other.

(Method of Producing Carbon Nanotube Composite 1B)

The following description will discuss a method of producing a CNT composite 1B in accordance with Embodiment 2, with reference to FIG. 9. (a) to (f) of FIG. 9 schematically illustrate a method of producing a CNT composite 1B.

The method of producing a CNT composite 1B in accordance with Embodiment 2 includes: a carbon nanotube preparing step (CNT preparing step); a first polymeric material applying step; a second polymeric material applying step; a transferring step; a polymeric material curing step; and a peeling step. The CNT preparing step is the same as that described in Embodiment 1, and therefore the descriptions therefor are omitted here.

The first polymeric material applying step is substantially the same as the polymeric material applying step of Embodiment 1, except that the precursor solution applied to the substrate B2 is a resin (i.e., second layer 12) precursor solution P2. Therefore, detailed descriptions for the first polymeric material applying step are omitted here.

The second polymeric material applying step includes applying, on the resin precursor solution P2 applied on the substrate B2, an elastic material (i.e., first layer 11) precursor solution P1 by, for example, a doctor blade method (see (a) and (b) of FIG. 9).

The transferring step includes transferring, to the elastic material precursor solution P1 and the resin precursor solution P2 applied on the substrate B2, a plurality of CNTs 20 prepared on the substrate B1.

Specifically, in the transferring step, first, as illustrated in (c) of FIG. 9, the plurality of CNTs 20 prepared on the substrate B1 are pressed into the elastic material precursor solution P1 and the resin precursor solution P2 applied on the substrate B2, in the direction indicated by the arrow (downward) in (c) of FIG. 9. This is carried out until the end portions 20b of the plurality of CNTs 20 reach the interior of the resin precursor solution P2. With this, the CNTs 20 are inserted in the elastic material precursor solution P1 and the resin precursor solution P2 (see (d) of FIG. 9).

The polymeric material curing step includes allowing the elastic material precursor solution P1 and the resin precursor solution P2 to cure by heating (or drying) the elastic material precursor solution P1 and the resin precursor solution P2. This results in formation of the base layer 10A, and thereby the plurality of CNTs 20 are fixed to the base layer 10A.

The peeling step includes peeling the base layer 10A (second layer 12) away from the substrate B2 and peeling the plurality of CNTs 20 away from the substrate B1 (see (e) of FIG. 9). Specifically, the substrate B1 and the CNTs 20 are separated from each other with use of, for example, a cutter, and the substrate B1 is peeled away from the CNTs 20 in the upward direction in (e) of FIG. 9. Similarly, the substrate B2 and the base layer 10A (second layer 12) are separated from each other with use of, for example, a cutter, and the substrate B2 is peeled away from the base layer 10A in the downward direction in (e) of FIG. 9. In this way, the plurality of CNTs 20 are transferred to the base layer 10A.

In this way, it is possible to produce a CNT composite 1B in which the end portions 20a of the CNTs 20 are exposed on the first face 10a of the first layer 10 of the base layer 10A and that the end portions 20b, which are opposite from the end portions 20a, of the CNTs 20 are located inside the second layer 12 (see (f) of FIG. 9).

Note that, although the CNT composite 1B in accordance with Embodiment 2 is arranged such that the base layer 10A is constituted by two layers (first layer 11 and second layer 12), the CNT composite of the present invention is not limited as such. In an aspect of the present invention, the base layer of the CNT composite may be constituted by three or more layers. This makes it possible to achieve a CNT composite that has three or more functions (examples of the functions other than the foregoing functions include heat dissipating function and waterproof function). Therefore, in an aspect of the present invention, the CNT composite can be applied to, for example, a heat dissipating material. In a case where the base layer is constituted by three or more layers, the CNT composite may be formed such that CNTs 20 are present within all the layers or may be formed such that CNTs 20 are present only within a layer that forms a surface of the CNT composite. Alternatively, the CNT composite may be formed such that CNTs 20 are present within at least one but not all of the layers.

The so far described embodiments deal with arrangements in which a plurality of CNTs 20 prepared on the substrate B1 are transferred to a base layer and then the substrate B1 is peeled away from the CNTs 20. Note, however, that a method of producing a CNT composite of the present invention is not limited as such. In an aspect of the present invention, the following arrangement may be employed: a plurality of CNTs 20 are separated (peeled away) from the substrate B1 with use of, for example, a cutter and thereby a sheet constituted by the plurality of CNTs 20 is prepared first; and then the CNTs 20 in the form of the sheet are transferred (fixed) to a base layer.

The present invention is not limited to the embodiments, but can be altered by a skilled person in the art within the scope of the claims. The present invention also encompasses, in its technical scope, any embodiment derived by combining technical means disclosed in differing embodiments.

### REFERENCE SIGNS LIST

1, 1A, 1B carbon nanotube composite (CNT composite)
10, 10A base layer
20 carbon nanotube (CNT)
20a end portion
22 amorphous layer (amorphous carbon)
22 vertically aligned carbon nanotube array
40 (vertically aligned CNT array)

1. A carbon nanotube composite comprising:
vertically oriented carbon nanotubes coated with amorphous carbon; and
a base layer which has the vertically oriented carbon nanotubes fixed thereto,
each of the vertically oriented carbon nanotubes having first and second opposite ends in a direction of orientation of the vertically oriented carbon nanotubes, at least one of the first and second opposite ends being exposed on an outside of the base layer.

2. The carbon nanotube composite as set forth in claim 1, wherein the base layer is constituted by at least two layers which are stacked together in the direction of orientation, the at least two layers being made of respective different materials.

3. The carbon nanotube composite as set forth in claim 2, wherein the vertically oriented carbon nanotubes are present within the at least two layers.

4. The carbon nanotube composite as set forth in claim 1, wherein the base layer includes a layer that contains an elastic material.

5. A method of producing a carbon nanotube composite, the method comprising:
a carbon nanotube preparing step comprising preparing vertically oriented carbon nanotubes on a substrate and coating amorphous carbon on the vertically oriented carbon nanotubes; and
a fixing step comprising fixing the vertically oriented carbon nanotubes to a base layer.
